(19) United States
(12) Patent Application Publication
(10) Pub. No.: US 2012/0145904 A1
(43) Pub. Date: Jun. 14, 2012

(54) WIRELESS RADIATION SENSOR

(75) Inventors: Fu-Jen Kao, Taipei (TW); Bo-Jau Kuo, Taipei (TW); I-Te Hsieh, Taipei (TW); Thilo Dellwig, Taipei (TW)

(73) Assignee: NATIONAL YANG MING UNIVERSITY

(21) Appl. No.: 12/970,584

(22) Filed: Dec. 16, 2010

(30) Foreign Application Priority Data
Dec. 10, 2010 (TW) 099143334

(51) Int. Cl. G01T 1/00

(52) U.S. Cl. 250/336.1

(57) ABSTRACT

A wireless radiation sensor is disclosed. The wireless radiation sensor including a radiation sensing module capable of detecting radiation and generate pulsed signals; a wireless module (which can be a passive component/high-frequency antenna) that is connected to the radiation sensing module, which is capable of transmitting the pulsed signals without signal processing, which are received by a computer for data analysis, and a power supply module that is connected to the radiation sensing module and/or wireless module (if an active transmitting module is used) to supply required electricity.

### CROSS-REFERENCED TO RELATED APPLICATIONS

This Non-provisional application claims priority under 35 U.S.C. §119(a) on Patent Application No(s). [099143334] filed on Dec. 10, 2010 Republic of China, the entire contents of which are hereby incorporated by reference.

### FIELD OF THE INVENTION

This present invention is a radiation sensing device, and, in particular, is a wireless radiation sensor.

### BACKGROUND OF THE INVENTION

In the field of radiation detection, radiation of various wavelengths, comprising infrared light, ultraviolet radiation, visible light, X-ray radiation, alpha particles, beta particles, and gamma rays can be detected. Various designs fulfill different requirements, for use in industry, the military or medical science.

For example, Geiger counters are used to detect ionizing radiation. An inert gas-filled tube (usually filled with helium, neon or argon with added halogens) briefly conducts electricity when a particle or photon of radiation makes the gas conductive. The tube amplifies this conduction by a cascade effect and outputs a current pulse, which is then commonly displayed as the movement of a needle or lamp and/or audible clicks.

In the medical field, light emitting moieties are extensively used for a number of purposes, including analyzing intra-cell metabolism, diagnosing cancer and monitoring physiological processes. The broad availability of modern laser-based non-invasive optical analysis methods, such as fluorescence lifetime analysis (FLT) in combination with fluorescent dye cell markers that approved for human application, such as indocyanine green (ICG, approved by the American FDA), has provided an opportunity for the in vivo monitoring and analysis of such physiological processes.

However, these methods of radiation detection require well-trained operators and an appropriately equipped laboratory. Most of the devices have complex electronic components and are bulky.

### SUMMARY OF THE INVENTION

This present invention relates to a wireless radiation sensor.

One embodiment of the present invention, a wireless radiation sensor, including a radiation sensing module that can detect radiation and generate high-frequency pulsed signals; a wireless module that is connected to the radiation sensing module, which is capable of transmitting high-frequency pulsed signals without processing, which are received by a computer for data analysis, and a power supply module that is connected to the radiation sensing module and/ or wireless module, to supply the required electricity. The high-frequency pulsed signals are transmitted by the wireless module without signal processing.

Preferably, the radiation comprises infrared light, ultraviolet radiation, visible light, X-ray radiation, alpha particles, beta particles, and gamma rays.

Preferably, the high-frequency pulsed signals are received by a computer for data analysis.

Preferably, the radiation sensing module comprises a photo detector or a radiation detector.

Preferably, the radiation sensing module is further integrated with a microcontroller module that is adapted to process the pulsed signals.

Preferably, the wireless radiation sensor is connected with a data collection and storage device which contains operational information to support offline reading and analysis.

Preferably, the wireless radiation sensor is integrated into an electronic circuit to provide an electronic connection between each module and power supply module.

The design of the modules, disclosed herein, in the present invention, can be based upon components that are used for unrelated applications, to maximize the cost-effectiveness of development and manufacturing.

Technical advantages are gained by using off-the-shelf components that require only slight modification, with minimal design costs and time-to-market. Commodity components, such as DVD/CD read/write heads, can be used to minimize the per-part costs. Well-established wireless communication-based data transfer and analysis methods can be used to minimize design costs, and maximize reliability, safety, and ease-of-use.

The invention has the ease-of-use advantage that it does not require invasive surgery. Meanwhile, no specialized technician is required to operate the sensor. A patient can easily operate the sensing module individually. This fact is especially important for patients with psychological or moral issues regarding diagnosis by others, for example, in the courses of breast cancer checkups. The collected data can be analyzed using either an automated computer program or an expert at any time, and no dedicated laboratory is required.

### BRIEF DESCRIPTION OF THE DRAWINGS

FIG. 1 is a system diagram of the wireless radiation sensor of the present invention;

FIG. 2 is a system diagram of the first embodiment of wireless radiation sensor of the present invention;

FIG. 3 is a sectional view of wireless radiation sensor of the first embodiment; and

FIG. 4 is a system diagram of the second embodiment of wireless radiation sensor of the present invention.

### DETAILED DESCRIPTION

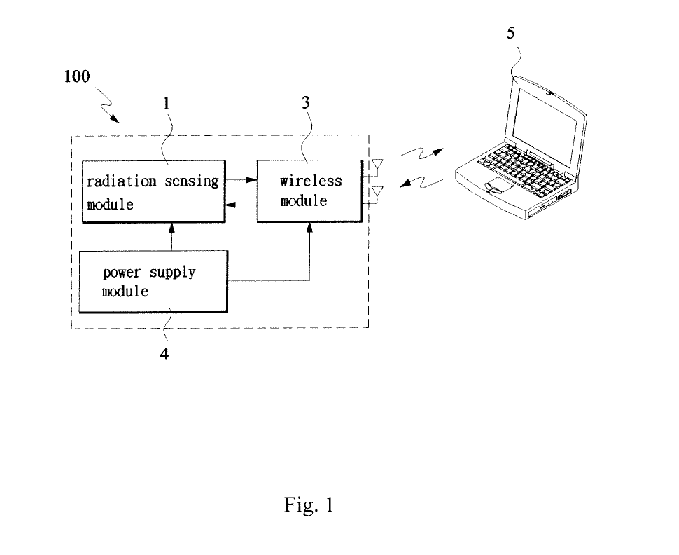

FIG. 1 shows the system diagram of the newly invented wireless radiation sensor. The wireless radiation sensor 100 comprises a radiation sensing module 1, a wireless module 3, and a power supply module 4. The radiation sensing module 1 (which can be a passive component/high-frequency antenna) is capable of detecting radiation and generating high-frequency pulsed signals. The wireless module 3 is connected to the radiation sensing module 1 and capable of transmitting the high-frequency pulsed signals without signal processing, before they are received by a computer 5 for data analysis. The power supply module 4 is connected to the radiation sensing module 1 and/ or wireless module 3 to supply required electricity. (No connection is made with wireless module 3 if contains an active component.). Installing different radiation sensing modules enables the wireless radiation sensor 100 to detect radiation of various wavelengths, such as infrared light, ultraviolet radiation, visible light, X-ray radiation, alpha particles, beta particles, and gamma rays.

### Embodiment 1

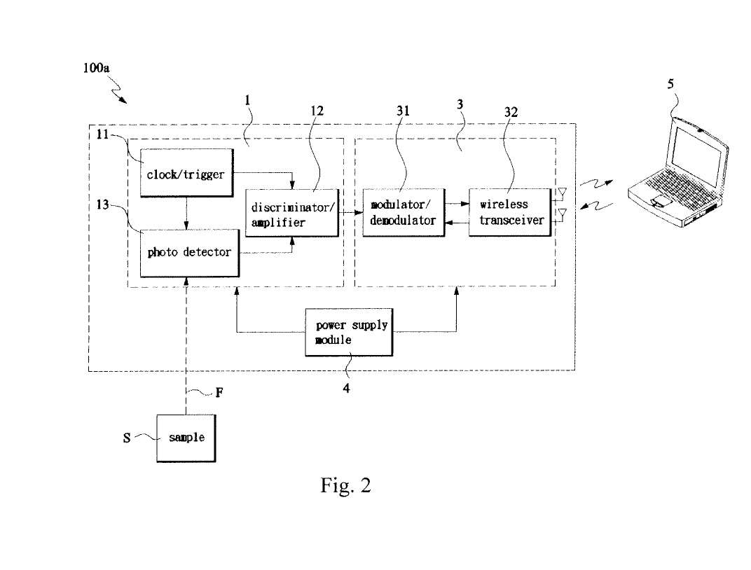

With reference to FIG. 2, the wireless radiation sensor 100a comprises an optimal module 1, a wireless module 3, and a power supply module 4.

The radiation sensing module 1 including a clock/trigger 11, a discriminator/amplifier 12 and a photo detector 13 (or a radiation detector). The clock/trigger 11 is adapted to generate a timebase and drives the components of the photo detector 13, such as laser diodes and APD. The discriminator/amplifier 12 is adapted to receive the output signal from the APD, which is gated by a signal from the clock/trigger 11, which can amplify and transmit the pulsed signal to the wireless module 3. Generally, laser beams are emitted onto a sample S by an external laser source, and the fluorescence signals F of the sample S, excited by these laser beams, can be detected by the radiation sensing module 1 to generate pulsed signals. Preferably, the laser beams and the detected fluorescence signals are in the visible (VIS) and near-infrared (NIR) spectral ranges, respectively.

The wireless module 3 comprises a modulator/demodulator 31 and a wireless transceiver 32. The wireless module 3 is electronically connected to the radiation sensing module 1 and can transmit the pulsed signals to a computer 5 for data analysis without signal processing.

The power supply module 4 powers the radiation sensing module 1 and the wireless module 3. The wireless module 3 contains all of the components that are required to receive the signal from radiation sensing module 1, and to transmit the data through wireless interface to the receiving computer 5.

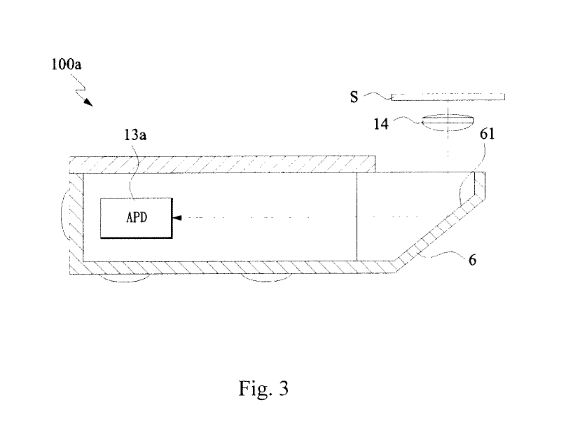

FIG. 3 shows a cross-sectional view of the wireless radiation sensor 100a. All of the components that are described above are utilized partially visible in this embodiment. The radiation sensing module 1 is described in detail and other modules, such as wireless module 3, are omitted, and not shown in the figure. In particular, the radiation sensing module 1, mentioned above, can be an avalanche photodiode (APD) 13a, that is mounted inside the plastic housing 6, as a means for detecting fluorescence signals.

For example, upon excitation by laser beams, sample S emits fluorescence signals, which are collimated by objective lens 14, reflected by TIR surface 61 and received by avalanche photo diode (APD) 13a.

### Embodiment 2

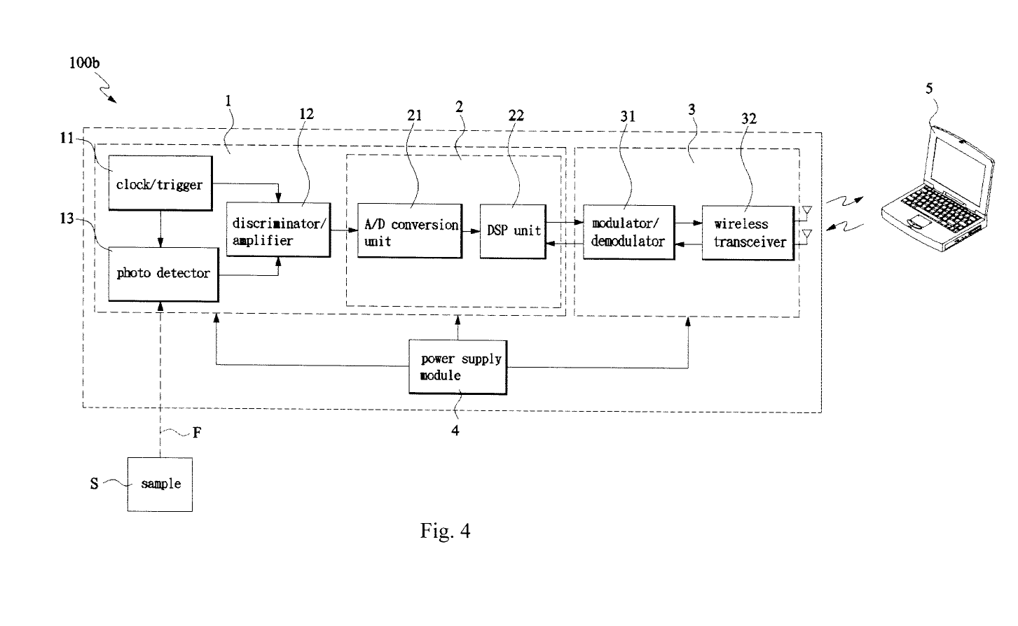

FIG. 4 shows the second embodiment of the wireless radiation sensor 100b. As shown in the system diagram, the wireless radiation sensor 100b including an radiation sensing module 1, a wireless module 3 and a power supply module 4, of which the radiation sensing module 1 is further integrated with a microcontroller module 2, which is adapted to process the pulsed signals. The radiation sensing module 1, microcontroller module 2, wireless module 3 and power supply module 4, are functionally similar to those described in the first embodiment. Only the microcontroller module 2 is characterized below.

The microcontroller module 2 including an analog/digital (A/D) conversion unit 21 and a digital signal processing (DSP) unit 22. The microcontroller module 2 is electronically connected to the wireless module 3, and is capable of processing the pulsed signals. After signal processing, the pulsed signals are wirelessly transmitted by wireless module 3 to a computer for data analysis, as described above.

The advantages of the present invention are as follows. Each component of the wireless radiation sensor can be easily obtained off-the-shelf (this is not a necessary requirement for a patent). For example, the optical module of the wireless radiation sensor can be made by replacing some of the components in a commercially available monolithic DVD/CD read/write head to improve functionality (if we are detecting gamma ray or non-optical radiation, the DVD/CD components will not be used.): the optical coating of the beam splitters can be adapted, and the diffraction grating removed. Also, modules can be connected to the wireless module by regular wiring or using a woven electronic circuit. For example, the electronic circuit can be a custom-tailored woven electronic textile shirt, trouser or other garment. The shape of the electronic circuit is not limited in the invention. Accordingly, This low-cost embodiment can be used in animal experiments in which high marker dye dosages are utilized.

In a further embodiment of the present invention, the wavelength of the laser diodes is selected such that one emits light at the excitation wavelength of a specific light-emitting moiety, such as 780 nm for ICG, while the other emits light at the fluorescence wavelength of a specific light-emitting moiety, such as 820 nm for ICG, or at one of the Stokes or anti-Stokes shifted emission wavelengths of a light-emitting moiety. The APD may be selected to maximize the sensitivity at the second wavelength. This setup enables the detection of stimulated emission fluorescence or stimulated Raman emission signals.

In a further embodiment of the present invention, the radiation sensing module, microcontroller module, wireless module and power supply module are integrated into a single housing, to form an integrated sensor, preferably by integrating all required electronics into a single microchip or a single multilayer electrical board.

In a further embodiment of the present invention, the sensor can be linked to an electronic data acquisition and storage device, to record operational data, for offline readout and analysis.

In a further embodiment of the invention, one or more of the integrated sensors that are described above may be integrated into a custom-tailored woven electronic textile shirt, trouser or other garment that provides the appropriate electrical connections between the power supply module and various other modules.

While this invention has been particularly shown and described with references to preferred embodiments thereof, it will be understood by those skilled in the art that various changes in form and details may be made therein without departing from the scope of the invention encompassed by the appended claims.

What is claimed is:

1. A wireless radiation sensor, comprising:
a radiation sensing module capable of detecting radiation and generating high-frequency pulsed signals;
a wireless module connected to the radiation sensing module, which is capable of transmitting the high-frequency pulsed signals without signal processing before receiving by a computer for data analysis; and
a power supply module connected to the radiation sensing module or wireless module to supply required electricity;
wherein the high-frequency pulsed signals are transmitted by the wireless module without signal processing.

2. The wireless radiation sensor as claimed in claim 1, wherein the radiation comprises infrared light, ultraviolet radiation, visible light, X-ray radiation, alpha particles, beta particles, and gamma rays.

3. The wireless radiation sensor as claimed in claim 1, wherein the high-frequency pulsed signals are received by a computer for data analysis.

4. The wireless radiation sensor as claimed in claim 1, wherein the radiation sensing module further comprises a photo detector or a radiation detector.

5. The wireless radiation sensor as claimed in claim 1, wherein the radiation sensing module is further integrated with a microcontroller module adapted to process the pulsed signals.

6. The wireless radiation sensor as claimed in claim 1, further connected with a data collection and storage device having operational information for offline reading and analysis.

7. The wireless radiation sensor as claimed in claim 1 further being integrated into an electronic circuit to provide electronic connection between each module and power supply module.

8. The wireless radiation sensor as claimed in claim 7, wherein the electronic circuit can be a custom-tailored woven electronic textile shirt, trouser or other garment.
